(19) United States
(12) Patent Application Publication
(10) Pub. No.: US 2004/0028891 A1
(43) Pub. Date: Feb. 12, 2004

(54) Porous media and method of manufacturing same

(76) Inventor: John W. Coleman, Saline, MI (US)

Correspondence Address: HARNESS, DICKEY & PIERCE, P.L.C., P.O. BOX 828, BLOOMFIELD HILLS, MI, 48303, US

(21) Appl. No.: 10/409,264

(22) Filed: Apr. 8, 2003

Related U.S. Application Data
(60) Provisional application No. 60/401,699, filed on Aug. 6, 2002.

(51) Int. Cl. B32B 3/26; B32B 9/00

(52) U.S. Cl. 428/319.1; 428/304.4; 428/318.4

(57) ABSTRACT

A metallic porous media being made from a porous base structure having a plurality of link strands extending throughout the porous base structure to define a plurality of open cells. The porous base structure is sprayed with an atomized molten metal spray such that each of the plurality of link strands is generally coated on all sides with the atomized molten metal spray to produce a porous metallic media.

### CROSS-REFERENCE TO RELATED APPLICATIONS

This application claims the benefit of U.S. Provisional Application No. 60/401,699, filed on Aug. 6, 2002. The disclosure of the above application is incorporated herein by reference.

### FIELD OF THE INVENTION

The present invention relates to porous media and, more particularly, relates to a porous media being constructed of a foam substrate and atomized metal layers and a method of making the same.

### BACKGROUND OF THE INVENTION

As is well known in the relevant art, porous media in general can be used in a wide variety of applications. These applications may include sound dampening, heat exchange, sandwich constructions (such as wallboard), batteries, metal sponges, and the like. Porous media may be manufactured by any one of a number of manufacturing techniques and with any one of a number of materials. Metallic porous media is often referred to as metal sponges. Therefore, these terms will be interchangeably used herein.

Conventionally, metal sponges are manufactured according to several known methods. These methods include dipping a reticulated foam into slurry, injecting a liquid metal mixture into a framework that has been allowed to dry and harden, electroplating, casting, and the like. Additionally, gas bubbling into a liquid metal or vapor depositing a gas metal onto a foam may be used. However, as one skilled in the art will readily appreciate, these conventional methods are often costly, environmentally unfriendly, and require lengthy production time. These conventional methods may fail to completely and reliably coat the underlying structure with metal. This failure to coat the underlying structure may limit the applicability of the resultant product in many applications. Furthermore, these conventional method are limited to relatively few types of metals.

Accordingly, there exists a need in the relevant art to provide a porous media that can be quickly and reliably manufactured of both conventional and non-conventional metals. Furthermore, there exists a need in the relevant art to provide a metallic porous media having a completely and uniformly applied metallic coating thereon that can be used in demanding heat transfer, acoustic dampening, and other applications. Still further, there exists a need in the relevant art to provide a metallic porous media that is capable of overcoming the disadvantages of the prior art.

### SUMMARY OF THE INVENTION

According to the principles of the present invention, a metallic porous media is provided having an advantageous construction and method of making the same. The metallic porous media is made from a porous base structure having a plurality of link strands extending throughout the porous base structure to define a plurality of open cells. The porous base structure is sprayed with an atomized molten metal spray such that each of the plurality of link strands is generally coated on all sides with the atomized molten metal spray to produce a porous metallic media.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an enlarged perspective view illustrating a metallic porous media according to the principles of the present invention; and

FIG. 2 is a schematic side view illustrating the method of manufacturing the metallic porous media according to the principles of the present invention.

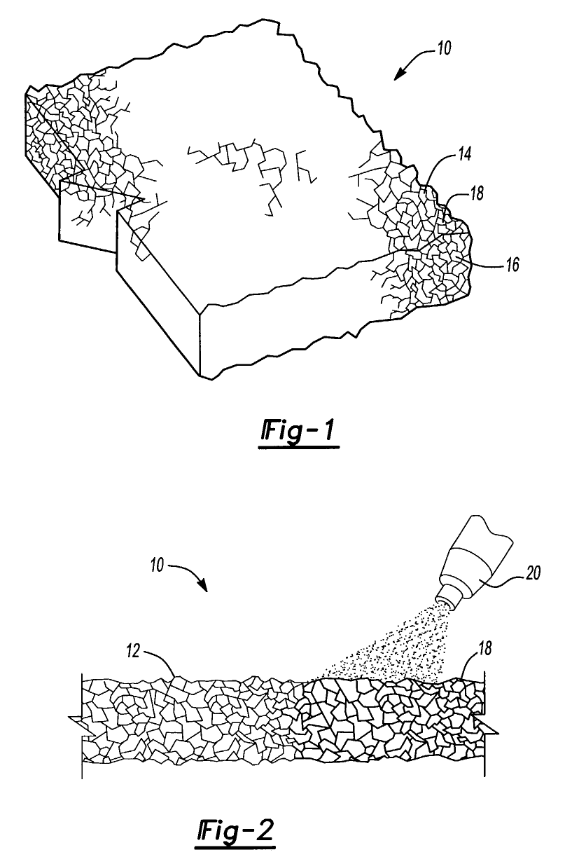

### DETAILED DESCRIPTION OF THE PREFERRED EMBODIMENT

The following description of the preferred embodiment is merely exemplary in nature and is in no way intended to limit the invention, its application, or uses. For example, the principles of the present invention may find utility in a wide variety of products and applications, such as, but not limited to, batteries, sandwich-style constructions (such as wallboards), acoustic dampening, cars, heat exchangers, microchips, filters, spargers, flame arrestors, and the like. Furthermore, the principles of the present invention should not be regarded as being limited to the specific metals set forth herein as it is anticipated that any one of a number of available metals, alloys, and chorded metals may be used in conjunction with the present invention.

Referring now to the drawings, a metallic porous media, generally indicated by reference numeral 10, according to the principles of the present invention is illustrated. Metallic porous media 10 generally includes a metal coated reticulated structure having a base structure or substrate 12. Base structure 12 includes a plurality of link strands 14 generally randomly extending throughout base structure 12 defining a plurality of open cells 16. The plurality of link strands 14 generally define the sponge-like structure of base structure 12 of metallic porous media 10. It should be appreciated, however, that a structure 12 may take any one of a number of conventional shapes, such as flat or curved.

Preferably, base structure 12 is made of any type of reticulated structure such as a polyurethane-based polymer foam. Many forms of reticulated structures are readily available in quantity. It should be appreciated that this polyurethane foam or other base structure may include any porosity that is conducive to the specific application and may be made of any material that is capable of receiving an atomized molten metal spray. Base structure 12 and, more particularly, the associated plurality of link strands 14 are coated along three dimensions through a process of applying an atomized molten metal spray or combination metal/non-metal spray to form a coating 18 that envelops base structure 12. This application process will be described in greater detail below.

Metal coating 18 permeates base structure 12 to form a metal layer over all sides of each of the plurality of link strands 14. Preferably, metal coating 18 may be made of any metal and/or alloy, such as, but not limited to, copper, aluminum, nickel, zinc, iron, aluminum alloy, steel, and the like. However, it should be appreciated that metal coating 18 may be a mixture of metal/non-metal materials. It should also be understood that metal coating 18 may include a plurality of different metal layers which may provided improved heat conductance, strength, electrical conductivity, or the like. Following the application of metal coating 18 upon base structure 12 there is formed a metallic porous media 10 that defines a sponge-like metallic member having a porosity to volume ratio that greatly exceeds a similarly sized metallic block, which makes metallic porous media 10 an excellent source for mechanical energy absorption. Furthermore, the increased surface area of metallic porous media 10 facilitates the use of metallic porous media 10 as an excellent heat transfer element.

During the manufacturing process, as seen in FIG. 2, uncoated base structure 12 is first provided. Base structure 12 is preferably a single continuous roll that would enable the uninterrupted manufacturing of metallic porous media 10. Although the present operation could be performed manually, it is also anticipated that for improved manufacturing rates, ease of manufacturing, and general consistency, it is preferred that the present operation be automated.

With particular reference to FIG. 2, it can be seen that base structure 12 is disposed along a manufacturing conveyor which transports base structure 12 into a position generally below a spray nozzle 20. Preferably, spray nozzle 20 is a metal arc sprayer. Briefly, a metal arc sprayer works by feeding a wire into the sprayer that uses an electric arc to melt the wire. A compressed gas is used to atomize the spray from the nozzle. This atomized spray is made up of tiny molten metal droplets which can be easily carried upon pressurized gas or other inert gas throughout the base structure 12 and deposited completely and uniformly. It should be appreciated that depending upon the material used for base structure 12, the application of the atomized metal spray may tend to flash a small amount of base structure 12. However, this does not appear to be particularly important considering the nearly instantaneous solidification of the atomized metal spray. Still referring to FIG. 2, following application of the atomized metal spray from spray nozzle 20, base structure 12 is now coated with metal coating 18 thereby defining metallic porous media 10. At this point, metallic porous media 10 may be further finished in accordance with the final application, such as by spraying more of a similar or dissimilar metal, cutting, shaping, drilling, brazing, sanding, annealing, sintering, compacting, sintering, compacting, or the like.

According to the principles of the present invention, a metallic porous media 10 and a method of making the same is provided having a number of distinct advantages over prior art methods. For example, the present invention provides a metallic porous media 10 defining an interlocking and/or interlaced link strand arrangements wherein each of the link strands is coated with metal in three dimensions. Depending upon the metal used for coating, metallic porous media 10 may be particularly adapted for a wide variety of different applications. By way of non-limiting example, metallic porous media 10 may find particular utility in heat exchange or applications where in a high surface area heat exchange or member is desired. Alternatively, metallic porous media 10 may also be used in battery-type applications, where large surface area in a compact package is desired. Still further, metallic porous media 10 may further be used in wall structures due to its strength capability and/or in acoustic applications where the plurality of link strands 14 serve to dissipate acoustic energy that attempts to permeate therethrough.

It should also be appreciated that the principles of the present invention may be equally applicable to small-scale applications such as the fabrication of onboard heat transfer element upon computer hardware. That is, an intricate base structure could be applied to computer processing chips and then coated with the atomized metal spray of the present invention to define a small-scale, high surface area heat transfer element specifically incorporated into the structure of the computer processing chip.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of manufacturing a porous media, said method comprising:
providing a porous base structure having a plurality of link strands extending throughout said porous base structure to define a plurality of open cells; and
spraying atomized molten spray upon said porous base structure such that each of said plurality of link strands is generally coated with said atomized molten spray to produce a porous media.

2. The method according to claim 1 wherein said molten spray is at least partially a metal spray.

3. The method according to claim 1, further comprising:
providing a conveyor;
disposing said porous base structure upon said conveyor; and
moving said porous base structure generally adjacent a spray nozzle prior to said spraying atomized molten spray upon said porous base structure.

4. The method according to claim 1 wherein said spraying atomized molten spray includes providing an arc sprayer for atomizing metal or cored metal.

5. The method according to claim 1 wherein said providing a porous base structure having a plurality of link strands includes providing a preformed reticulated structure.

6. The method according to claim 5 wherein said providing a preformed foam structure includes providing a polyurethane-based packaging or polymer foam.

7. The method according to claim 1 wherein said spraying atomized molten spray upon said porous base structure includes spraying atomized molten spray being made at least in part from a metal chosen from the group consisting essentially of copper, aluminum, nickel, zinc, iron, steel, silver, palladium, and any alloy thereof.

8. The method according to claim 1, further comprising:
finishing said porous media following said spraying atomized molten spray upon said porous base structure.

9. The method according to claim 8 wherein said finishing includes cutting, shaping, drilling, brazing, sanding, etching, annealing, sintering, compacting, or thermal processing.

10. The method according to claim 1 wherein said spraying atomized molten spray upon said porous base structure includes spraying atomized molten spray from a single nozzle located on only a single side of said porous base structure.

11. A heat exchanger element comprising:
a porous base structure;
a plurality of link strands extending throughout said porous base structure to define a plurality of open cells; and
a spray coating being applied as an atomized molten spray, said spray coating extending along all sides of said plurality of link strands while maintaining said plurality of open cells.

12. The heat exchanger element according to claim 11, wherein said spray coating is made at least in part of a metal chosen from the group consisting essentially of copper, aluminum, nickel, zinc, iron, steel, silver, palladium, and any alloy thereof.

13. The heat exchanger element according to claim 11, wherein said porous base structure is made of a preformed non-metallic foam structure.

14. The heat exchanger element according to claim 11, wherein said porous base structure is made of a polymer foam.

15. A method of manufacturing a porous media, said method comprising:
providing a porous base structure having a plurality of link strands extending throughout said porous base structure to define a plurality of open cells;
moving said porous base structure generally adjacent a spray nozzle;
arc spraying atomized molten metal spray upon said porous base structure such that each of said plurality of link strands is generally coated on all sides with said atomized molten metal spray to produce a porous metallic media.

16. The method according to claim 15 wherein said providing a porous base structure having a plurality of link strands includes providing a preformed non-metallic foam structure.

17. The method according to claim 16 wherein said providing a preformed foam structure includes providing a reticulated structure.

18. The method according to claim 15 wherein said arc spraying atomized molten metal spray upon said porous base structure includes arc spraying atomized molten metal spray being made from a metal chosen from the group consisting essentially of copper, aluminum, nickel, zinc, iron, steel, silver, palladium, and any alloy thereof.

19. The method according to claim 15, further comprising:
finishing said porous metallic media following said spraying atomized molten metal spray upon said porous base structure.

20. The method according to claim 19 wherein said finishing includes cutting, shaping, drilling, brazing, sanding, etching, annealing, sintering, compacting, or thermal processing.

21. The method according to claim 15 wherein said arc spraying atomized molten metal spray upon said porous base structure includes arc spraying atomized molten metal spray from a stationary arc spray nozzle located on only a single side of said porous base structure.
